(19) United States
(12) Patent Application Publication
(10) Pub. No.: US 2020/0364882 A1
(43) Pub. Date: Nov. 19, 2020

(54) METHOD AND APPARATUSES FOR TARGET TRACKING, AND STORAGE MEDIUM

(71) Applicant: BEIJING SENSETIME TECHNOLOGY DEVELOPMENT CO., LTD., Beijing (CN)

(72) Inventors: Weitao FENG, Beijing (CN); Zhihao HU, Beijing (CN); Wei WU, Beijing (CN)

(21) Appl. No.: 16/986,740

(22) Filed: Aug. 6, 2020

Related U.S. Application Data
(63) Continuation of application No. PCT/CN2019/111038, filed on Oct. 14, 2019.

(30) Foreign Application Priority Data
Jan. 17, 2019 (CN) 201910045247.8

(51) Int. Cl. G06T 7/246; G06T 7/70; G06K 9/00

(52) U.S. Cl. CPC G06T 7/246; G06T 7/70; G06K 9/00711; G06T 2207/30196; G06T 2207/10016; G06T 2207/30241; G06T 2207/20084; G06K 9/00771

(57) ABSTRACT

A method for target tracking includes: determining predicted target position information of at least one first target object and predicted blocking object position information of a respective blocking object according to a historical image frame; determining historical target appearance feature sequence of first target object and historical blocking object appearance feature sequence of blocking object according to historical image frame sequence; determining current target position information and current target appearance feature of second target object according to current image frame; determining target similarity information according to predicted target position information, historical target appearance feature sequence, current target position information and current target appearance feature; determining blocking object similarity information according to predicted blocking object position information, historical blocking object appearance feature sequence, current target position information and current target appearance feature; and determining a tracking trajectory of first target object according to target similarity information and blocking object similarity information.

### CROSS-REFERENCE TO RELATED APPLICATIONS

The present application is a continuation of International Application No. PCT/CN2019/111038, filed on Oct. 14, 2019, which claims priority to Chinese Patent Application No. 201910045247.8, filed on Jan. 17, 2019. The disclosures of International Application No. PCT/CN2019/111038 and Chinese Patent Application No. 201910045247.8 are hereby incorporated by reference in their entireties.

### BACKGROUND

Multi-Object-Tracking (MOT) is an important component of a video analysis system, such as a video monitoring system and a self-driving automobile. Existing MOT algorithms are mainly divided into two types. One is to directly use a variety of features to directly process a trajectory relationship, and the other is to perform single object tracking first, and then process a trajectory association relationship. However, neither of the two types of tracking algorithms can track a target accurately.

### SUMMARY

The present disclosure relates to the field of image processing, but not limited to, the field of image processing, and in particular, to a method and apparatuses for target tracking, and a storage medium.

The embodiments provide a method for target tracking, including: determining, according to a historical image frame adjacent to a current image frame, predicted target position information of at least one first target object and predicted blocking object position information of a respective blocking object, where each blocking object is a target closest to a respective first target object; determining, according to a historical image frame sequence before the current image frame, a historical target appearance feature sequence corresponding to the at least one first target object and a historical blocking object appearance feature sequence corresponding to the blocking object; determining, according to the current image frame, current target position information and a current target appearance feature of at least one second target object; determining target similarity information between each first target object and a respective second target object according to the predicted target position information, the historical target appearance feature sequence, the current target position information, and the current target appearance feature; determining blocking object similarity information according to the predicted blocking object position information, the historical blocking object appearance feature sequence, the current target position information, and the current target appearance feature; and determining a tracking trajectory of the at least one first target object according to the target similarity information and the blocking object similarity information.

The embodiments provide an apparatus for target tracking, including: a memory storing processor-executable instructions; and a processor arranged to execute the stored processor-executable instructions to perform operations of: determining, according to a historical image frame adjacent to a current image frame, predicted target position information of at least one first target object and predicted blocking object position information of a respective blocking object, where each blocking object is a target closest to a respective first target object; determining, according to a historical image frame sequence before the current image frame, a historical target appearance feature sequence corresponding to the at least one first target object and a historical blocking object appearance feature sequence corresponding to the blocking object; determining, according to the current image frame, the current target position information and the current target appearance feature of at least one second target object; determining target similarity information between each first target objects and a respective second target object according to the predicted target position information, the historical target appearance feature sequence, the current target position information, and the current target appearance feature; determining blocking object similarity information according to the predicted blocking object position information, the historical blocking object appearance feature sequence, the current target position information, and the current target appearance feature; and determining a tracking trajectory of the at least one first target object according to the target similarity information and the blocking object similarity information.

The embodiments provide a non-transitory computer readable storage medium having stored thereon computer readable instructions that, when executed by a processor, cause the processor to perform a method for target tracking, the method including: determining, according to a historical image frame adjacent to a current image frame, predicted target position information of at least one first target object and predicted blocking object position information of a respective blocking object, wherein each blocking object is a target closest to a respective first target object; determining, according to a historical image frame sequence before the current image frame, a historical target appearance feature sequence corresponding to the at least one first target object and a historical blocking object appearance feature sequence corresponding to the blocking object; determining, according to the current image frame, current target position information and a current target appearance feature of at least one second target object; determining target similarity information between each first target object and a respective second target object according to the predicted target position information, the historical target appearance feature sequence, the current target position information, and the current target appearance feature; determining blocking object similarity information according to the predicted blocking object position information, the historical blocking object appearance feature sequence, the current target position information, and the current target appearance feature; and determining a tracking trajectory of the at least one first target object according to the target similarity information and the blocking object similarity information.

### BRIEF DESCRIPTION OF THE DRAWINGS

The accompanying drawings here, which are incorporated in the specification and constituting a part of the specification, illustrate embodiments consistent with the present disclosure and are used for explaining the technical solutions of the present disclosure together with the specification.

FIG. 1 is a flowchart of a method for target tracking provided by the embodiments;

FIG. 2 is a schematic flowchart of an exemplary method for target tracking provided by the embodiments;

FIG. 3 is a first schematic structural diagram of an apparatus for target tracking provided by the embodiments; and

FIG. 4 is a second schematic structural diagram of an apparatus for target tracking provided by the embodiments.

### DETAILED DESCRIPTION

It should be understood that the specific embodiments described herein are merely used for explaining the present disclosure, rather than limiting the present disclosure.

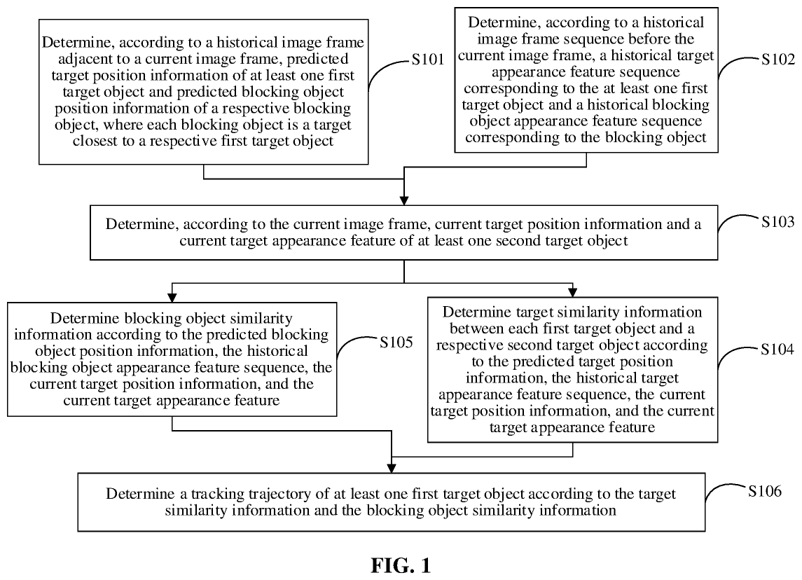

The embodiments disclose a method for target tracking. As shown in FIG. 1, the method is applied to various tracking devices, and includes the following steps.

At step S101, predicted target position information of at least one first target object and predicted blocking object position information of a respective blocking object are determined according to a historical image frame adjacent to a current image frame, where each blocking object is a target closest to a respective first target object.

The tracking device may include a tracking terminal and/or a tracking server.

The tracking device may include an image processing device capable of image processing. For example, the image processing device may include an image acquiring module (for example, a monocular or multinocular camera) capable of acquiring image frames, and using a processor to process the image frames for target tracking. For another example, the image processing device may not acquire images by itself but receive image frames from image acquiring device, and perform image processing on the image frames received from the image acquiring device so as to implement target tracking.

The tracking server is located on a network side, the image acquiring device uploads the acquired image frames to the tracking server, and the tracking server performs target tracking after receiving the image frames.

The method for target tracking may be applied to different application scenarios. For example, when the method for target tracking is applied to the field of security, the tracking device may be a security device. Various devices for security control are usually provided at the gate of a factory, a commercial building, or a community so as to monitor persons and/or vehicles entering the factory or the community, and the tracking device analyzes image frames contained in a video according to the acquired video, thereby implementing the tracking of the persons and/or the vehicles.

The method for target tracking may also be applied in the field of road traffic, image acquiring devices for acquiring the image frames are provided on both sides of a road, and the tracking device performs image analysis after obtaining these image frames to implement target tracking, thereby tracking persons or vehicles that violate a road traffic regulation.

In some embodiments, the current image frame is an image frame that is being processed at a current moment, and the historical image frame is an image frame acquired before the current image frame. For example, if the current image frame is an image frame acquired at a first moment and the historical image frame is an image frame acquired at a second moment, the second moment is earlier than the first moment.

The method for target tracking provided by the embodiments is applicable to a scenario where multiple targets are tracked in a video.

In the embodiments, the first target objects are targets that are tracked. For example, targets in the historical image frame may be persons, vehicles, or the like, specifically, selection is performed according to an actual situation, and no specific limitation is made in the embodiments. The first target objects may be one of multiple targets that are tracked.

In the embodiments, an apparatus for target tracking determines the first target object(s) and the blocking object closest to the respective first target object in the historical image frame, and then determines the predicted target position information of the first target objects and the predicted blocking object position information of the blocking object using a neural network capable of implementing Single Object Tracking (SOT).

In the embodiments, the neural network capable of implementing SOT may utilize a network composed of an SOT algorithm.

In the embodiments, the apparatus for target tracking forms target bounding rectangles including the first target objects in the historical image frame; and then, the apparatus for target tracking determines an additional target object with the value obtained by dividing the intersection area obtained by finding an intersection of any two target bounding rectangles by the union area obtained by finding an union of the corresponding two target bounding rectangles being maximum as the blocking object closest to the first target object.

In the embodiments, the apparatus for target tracking obtains an adjacent image frame before the current image frame as the historical image frame, and determines the predicted target position information of the first target objects in the current image frame and the predicted blocking object position information of the blocking object in the current image frame using the SOT algorithm.

In some embodiments, the SOT algorithm includes a Siamese Region Proposal Network method, a Siamese Fully Convolutional method, or the like, specifically, selection is performed according to an actual situation, and no specific limitation is made in the embodiments.

In the embodiments, the position information may include coordinate information or latitude and longitude information, specifically, selection is performed according to an actual situation, and no specific limitation is made in the embodiments.

At step S102, a historical target appearance feature sequence corresponding to the at least one first target object and a historical blocking object appearance feature sequence corresponding to the blocking object are determined according to a historical image frame sequence before the current image frame.

In the embodiments, the apparatus for target tracking determines first target object(s) and a blocking object closest to the respective first target object according to the historical image frame sequence before the current image frame, and then determines the historical target appearance feature sequence corresponding to the at least one first target object and the historical blocking object appearance feature sequence corresponding to the blocking object using a Person Re-identification (ReID) algorithm.

In the embodiments, the apparatus for target tracking obtains consecutive multiple image frames before the current image frame as the historical image frame sequence, and determines the historical target appearance feature sequence of the first target objects and the historical blocking object appearance feature sequence of the blocking object using a neural network capable of implementing ReID.

In the embodiments, a number of features in the historical target appearance feature sequence and a number of features in the historical blocking object appearance feature sequence have one-to-one correspondence to a number of frames of the historical image frame sequence, specifically, selection is performed according to an actual situation, and no specific limitation is made in the embodiments.

In the embodiments, the neural network capable of implementing ReID may utilize a network composed of a ReID algorithm.

In the embodiments, the ReID algorithm includes an Inception-v4 model.

In the embodiments, a number of the at least one first target object is more than one.

It should be noted that S101 and S102 are two parallel steps before S103, and there is no absolute timing relationship between S101 and S102, specifically, selection is performed according to an actual situation, and the execution order of the two is not limited in the embodiments.

At step S103, current target position information and a current target appearance feature of at least one second target object are determined according to the current image frame.

After the apparatus for target tracking determines the predicted target position information and the historical target appearance feature sequence corresponding to the at least one first target object, and the predicted blocking object position information and the historical blocking object appearance feature sequence corresponding to the blocking object, the apparatus for target tracking determines, according to the current image frame, the current target position information and the current target appearance feature corresponding to the at least one second target object.

In the embodiments, the apparatus for target tracking determines, according to the current image frame, the at least one second target object and the current target position information and the current target appearance feature corresponding to the at least one second target object.

In the embodiments, the first target objects and the at least one second target object are at least partially matched, that is, at least some of targets among the first target objects are matched with at least some of targets among the at least one second target object.

In the embodiments, a number of the at least one second target object is more than one.

At step S104, target similarity information between each first target object and a respective second target object is determined according to the predicted target position information, the historical target appearance feature sequence, the current target position information, and the current target appearance feature.

After the apparatus for target tracking determines the current target position information and the current target appearance feature corresponding to the at least one second target object in the current image frame, the apparatus for target tracking determines the target similarity information between each first target object and the respective second target object according to the predicted target position information, the historical target appearance feature sequence, the current target position information, and the current target appearance feature.

In the embodiments, the apparatus for target tracking determines a target position similarity according to the predicted target position information and the current target position information; the apparatus for target tracking determines a target appearance similarity sequence according to the historical target appearance feature sequence and the current target appearance feature; and then, the apparatus for target tracking determines the target position similarity and the target appearance similarity sequence as the target similarity information between each first target object and the respective second target object.

In the embodiments, the apparatus for target tracking performs similarity calculation on the predicted target position information and the current target position information to obtain the target position similarity; and the apparatus for target tracking performs similarity calculation on the historical target appearance feature sequence and the current target appearance feature to obtain the target appearance similarity sequence.

At step S105, blocking object similarity information is determined according to the predicted blocking object position information, the historical blocking object appearance feature sequence, the current target position information, and the current target appearance feature.

After the apparatus for target tracking determines the current target position information and the current target appearance feature corresponding to the at least one second target object in the current image frame, the apparatus for target tracking determines the blocking object similarity information according to the predicted blocking object position information, the historical blocking object appearance feature sequence, the current target position information, and the current target appearance feature.

In the embodiments, the apparatus for target tracking determines a blocking object position similarity according to the predicted blocking object position information and the current target position information; the apparatus for target tracking determines a blocking object appearance similarity according to the historical blocking object appearance feature sequence and the current target appearance feature; and then, the apparatus for target tracking determines the blocking object position similarity and the blocking object appearance similarity as the blocking object similarity information.

In the embodiments, the apparatus for target tracking performs similarity calculation on the predicted blocking object position information and the current target position information to obtain the blocking object position similarity; and the apparatus for target tracking performs similarity calculation on the historical blocking object appearance feature sequence and the current target appearance feature to obtain the blocking object appearance similarity.

In the embodiments, the target position similarity is the value obtained by dividing the intersection area of the target bounding rectangles by the union area thereof, and the target appearance similarity sequence is an appearance feature cosine included angle.

It should be noted that the calculation process of the blocking object position similarity is the same as that of the target position similarity, and the calculation process of the blocking object appearance similarity is the same as that of the target appearance similarity sequence. Details are not described herein again.

It should be noted that S104 and S105 are two parallel steps after S103 and before S106, and there is no absolute timing relationship between S104 and S105, specifically, selection is performed according to an actual situation, and the execution order of the two is not limited in the embodiments.

At step S106, a tracking trajectory of the at least one first target object is determined according to the target similarity information and the blocking object similarity information.

After the apparatus for target tracking determines the target similarity information and the blocking object similarity information, the apparatus for target tracking determines the tracking trajectory of the at least one first target object according to the target similarity information and the blocking object similarity information.

In the embodiments, the apparatus for target tracking determines a target trajectory association relationship between the first target object and the respective second target object according to the target similarity information and the blocking object similarity information; and the apparatus for target tracking searches the at least one second target object for a target associated with the at least one first target object using the target trajectory association relationship to determine the tracking trajectory of the at least one first target object.

In the embodiments, the apparatus for target tracking inputs the target similarity information and the blocking object similarity information to a preset classifier; then, the apparatus for target tracking determines multiple decision scores of multiple trajectory association relationships using the preset classifier, where the multiple trajectory association relationships are trajectory association relationships obtained by performing trajectory association between the first target objects and the respective second target objects; and the apparatus for target tracking determines, as the target trajectory association relationship, a trajectory association relationship having a highest decision score among the multiple trajectory association relationships.

In the embodiments, the preset classifier outputs the decision scores between associated targets in the multiple trajectory association relationships, and then the decision scores in the trajectory association relationships are superimposed to obtain the decision scores corresponding to the trajectory association relationships. In this case, the multiple decision scores of the multiple trajectory association relationships are obtained.

In the embodiments, the apparatus for target tracking performs trajectory association between the first target object in the historical image frame and the respective second target object in the current image frame using a preset trajectory association algorithm so as to obtain the multiple trajectory association relationships between the first target objects and respective second target objects.

In the embodiments, the classifier uses a gradient boosting decision tree model.

In the embodiments, the preset trajectory association algorithm is a maximum weighted bipartite graph matching, i.e., a minimum cost maximum flow algorithm.

In some embodiments, after the apparatus for target tracking determines the target trajectory association relationship, the apparatus for target tracking determines a target associated with the at least one second target object from the first target objects in the target association relationship; if the apparatus for target tracking determines a third target object that is not associated with the at least one second target object from the first target objects in the target association relationship, the apparatus for target tracking obtains the predicted target position information according to a confidence value of the third target object; and then the apparatus for target tracking determines the tracking trajectory of the at least one first target object using the target association relationship and the predicted target position information.

Exemplarily, if the apparatus for target tracking determines the third target object that is not associated with the at least one second target object from the first target objects, the apparatus for target tracking determines that the third target object in the historical image frame does not appear in the current image frame. In this case, the reason why the apparatus for target tracking determines that the third target object does not appear in the current image frame is: the confidence value of the third target object does not meet a preset confidence threshold. If the confidence value of the third target object meets the preset confidence threshold, it is determined that the third target object is blocked in the current image frame by the blocking object. In this case, the apparatus for target tracking predicts the position of the third target object in the current image frame according to the predicted target position information corresponding to the third target object.

In some embodiments, the apparatus for target tracking determines a target associated with the at least one first target object from among the at least one second target object in the target association relationship; if the apparatus for target tracking determines a fourth target object that is not associated with the at least one first target object from among the at least one second target object in the target association relationship, the apparatus for target tracking adds the fourth target object to a next round of association relationship, where the next round of association relationship is an association relationship generated by taking the current image frame as the historical image frame.

Exemplarily, if the apparatus for target tracking determines the fourth target object that is not associated with the at least one first target object from among the at least one second target object, the fourth target object is characterized as a newly added target object. In this case, the apparatus for target tracking performs target tracking on the fourth target object.

In the embodiments, in the target association relationship, the matched target objects among the first target objects and the at least one second target object constitute a two-tuple, and the unmatched target objects among the first target objects and the at least one second target object constitute a one-tuple. The apparatus for target tracking searches the one-tuple for a target object among the at least one second target object as the fourth target object that is not associated with the at least one first target objects and the apparatus for target tracking searches the one-tuple for a target object among the first target objects as the third target object that is not associated with the at least one second target object.

In the embodiments, the apparatus for target tracking respectively calculates the confidence value and the predicted target position information of the first target object using the SOT algorithm.

In the embodiments, the apparatus for target tracking compares the confidence value corresponding to the third target object with a preset confidence value, and if the confidence value corresponding to the third target object meets the preset confidence value, the apparatus for target tracking obtains the predicted target position information.

It should be noted that the SOT algorithm, the ReID algorithm, the preset classifier, and the preset trajectory association algorithm in the embodiments are all alternative algorithms, specifically, selection is performed according to an actual situation, and no specific limitation is made in the embodiments.

In the embodiments, the apparatus for target tracking determines action trajectories of different target objects in a video from the target association relationship so as to track the target objects.

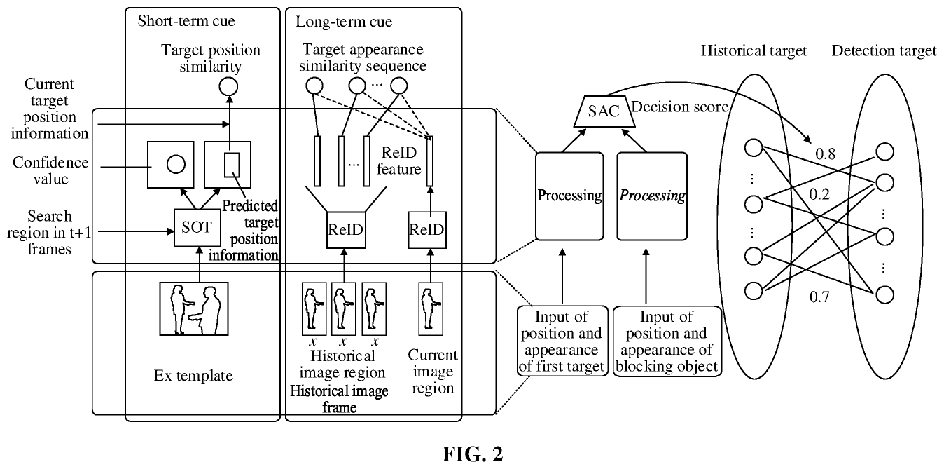

Exemplarily, as shown in FIG. 2, in short-term cues, an Ex template is input into a SOT algorithm sub-net to obtain predicted target position information D_{track} at time t+1 and a confidence score map, and then similarity calculation is performed on detected current target position information D_{det} at time t+1 and D_{trackl} to obtain a target position similarity fₛ(D_{track},D_{det}); in long-term cues, the current image region It+1, D_{det} corresponding to D_{det} is input into a ReID sub-net to obtain a current target appearance feature A_{det}, and a historical image region {Iₜ_{ᵢ}^{X}}, i=1, 2, . . . , K of the current target in the historical image frame is obtained and the historical image region is input into the ReID sub-net to obtain a historical target appearance feature sequence Aₜ_{ᵢ}^{X}, i=1, 2, . . . , K, then similarities between the current target appearance feature and the historical target appearance feature sequence are calculated sequentially to obtain a target appearance similarity sequence fₗ(Aₜ_{ᵢ}^{X},A_{det}), i=1, 2, . . . , K, then the target position similarity and the target appearance similarity sequence are input into a Switcher-Aware Classifier (SAC) sensitive to a blocking object to obtain multiple decision scores of multiple trajectory association relationships, and then a trajectory association relationship having a highest decision score is determined from the multiple trajectory association relationships as a target trajectory association relationship.

It may be understood that the apparatus for target tracking determines the predicted blocking object position information of the blocking object according to the historical image frame adjacent to the current image frame, determines the historical blocking object appearance feature sequence of the blocking object according to the historical image frame sequence before the current image frame, and fuses the predicted blocking object position information and the historical blocking object appearance feature sequence of the blocking object to determine the tracking trajectory of the at least one first target object in the historical image frame, so that during target tracking, because the predicted blocking object position information and the historical blocking object appearance feature sequence of the blocking object are used, the influence of the blocking object on the target tracking is reduced, thereby improving the accuracy of the target tracking.

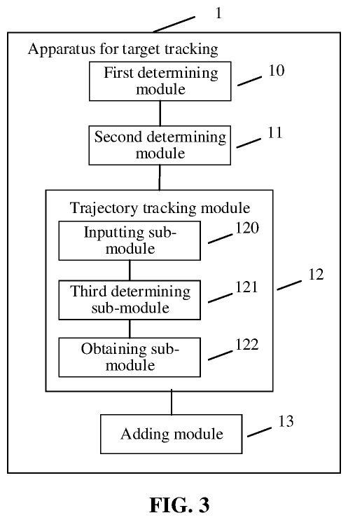

The embodiments provide an apparatus for target tracking 1. As shown in FIG. 3, the apparatus includes:

a first determining module 10, configured to determine, according to a historical image frame adjacent to a current image frame, predicted target position information of at least one first target object and predicted blocking object position information of a respective blocking object, where each blocking object is a target closest to a respective first target object; determine, according to a historical image frame sequence before the current image frame, a historical target appearance feature sequence corresponding to the at least one first target object and a historical blocking object appearance feature sequence corresponding to the blocking object; and determine, according to the current image frame, the current target position information and the current target appearance feature of at least one second target object;

a second determining module 11, configured to determine target similarity information between each first target object and a respective second target object according to the predicted target position information, the historical target appearance feature sequence, the current target position information, and the current target appearance feature; and determine blocking object similarity information according to the predicted blocking object position information, the historical blocking object appearance feature sequence, the current target position information, and the current target appearance feature; and

a trajectory tracking module 12, configured to determine a tracking trajectory of the at least one first target object according to the target similarity information and the blocking object similarity information.

In some embodiments, the first determining module 10 is further configured to determine a target position similarity according to the predicted target position information and the current target position information; determine a target appearance similarity sequence according to the historical target appearance feature sequence and the current target appearance feature; and determine the target position similarity and the target appearance similarity sequence as the target similarity information.

In some embodiments, the first determining module 10 is further configured to determine a blocking object position similarity according to the predicted blocking object position information and the current target position information; determine a blocking object appearance similarity according to the historical blocking object appearance feature sequence and the current target appearance feature; and determine the blocking object position similarity and the blocking object appearance similarity as the blocking object similarity information.

In some embodiments, the first determining module 10 is further configured to determine the predicted target position information and the predicted blocking object position information using a neural network capable of implementing SOT.

In some embodiments, the first determining module 10 is further configured to determine the historical target appearance feature sequence and the historical blocking object appearance feature sequence using a neural network capable of implementing ReID.

In some embodiments, the trajectory tracking module 12 is configured to determine a target trajectory association relationship between the first target object and the respective second target object according to the target similarity information and the blocking object similarity information; and search the at least one second target object for a target associated with the at least one first target object using the target trajectory association relationship to determine the tracking trajectory of the at least one first target object.

In some embodiments, the trajectory tracking module 12 includes an inputting sub-module 120 and a third determining sub-module 121;

the inputting sub-module 120 is configured to input the target similarity information and the blocking object similarity information to a preset classifier; and

the third determining sub-module 121 is further configured to determine multiple decision scores of multiple trajectory association relationships using the preset classifier, where the multiple trajectory association relationships are trajectory association relationships obtained by performing trajectory association between the first target objects and respective second target objects; and determine, as the target trajectory association relationship, a trajectory association relationship having a highest decision score among the multiple trajectory association relationships.

In some embodiments, the trajectory tracking module 12 further includes an obtaining sub-module 122;

the obtaining sub-module 122 is further configured to, if a third target object that is not associated with the at least one second target object is determined from among the at least one first target object in the target association relationship, obtain the predicted target position information according to a confidence value of the third target object; and

the third determining sub-module 121 is further configured to determine the tracking trajectory of the at least one first target object using the target association relationship and the predicted target position information.

In some embodiments, the apparatus further includes an adding module 13;

the adding module 13 is further configured to, if a fourth target object that is not associated with the at least one first target object is determined from among the at least one second target object in the target association relationship, add the fourth target object to a next round of association relationship, where the next round of association relationship is an association relationship generated by taking the current image frame as the historical image frame.

In some embodiments, the second determining module 11 is further configured to determine a confidence value corresponding to the first target object using the neural network capable of implementing SOT.

In some embodiments, the obtaining sub-module 122 is further configured to, if the confidence value of the third target object meets a preset confidence value, obtain the predicted target position information.

In some embodiments, a number of the at least one first target object and a number of the at least one second target object are both more than one.

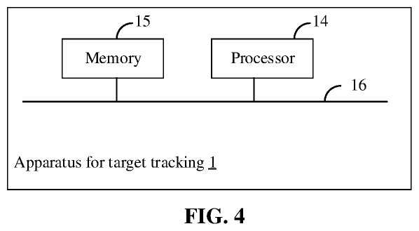

FIG. 4 is a first schematic structural composition diagram of the apparatus for target tracking 1 provided by the embodiments. In actual applications, on the basis of the same disclosed concept of the embodiments above, as shown in FIG. 4, the apparatus for target tracking 1 of the embodiments includes a processor 14, a memory 15, and a communication bus 16. The first determining module 10, the second determining module 11, the trajectory tracking module 12, the inputting sub-module 120, the third determining sub-module 121, the obtaining sub-module 122, and the adding module 13 are implemented by the processor 14.

In the specific embodiments, the processor 14 may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a CPU, a controller, a microcontroller, or a microprocessor It may be understood that, for different devices, an electronic device used for implementing the functions of the processor may be another one, and no specific limitation is made in the embodiments.

In the embodiments of the present disclosure, the communication bus 16 is used for connection and communication between the processor 14 and the memory 15, and the processor 14 is used for executing a running program stored in the memory 15 to implement the method according to the embodiments above.

The embodiments provide a computer readable storage medium, which stores one or more programs that can be executed by one or more processors and is applied to an apparatus for target tracking, where when the program(s) is/are executed by the processor(s), the method according to the embodiments above is implemented.

The embodiments further provide a computer program product, where when the computer program product is executed by a processor, the method for target tracking according to any one of the foregoing technical solutions can be implemented.

The embodiments disclose a method and apparatuses for target tracking, and a storage medium. The method includes: determining, according to a historical image frame adjacent to a current image frame, predicted target position information of at least one first target object and predicted blocking object position information of a respective blocking object; determining, according to a historical image frame sequence before the current image frame, a historical target appearance feature sequence corresponding to the at least one first target object and a historical blocking object appearance feature sequence corresponding to the blocking object; determining, according to the current image frame, current target position information and a current target appearance feature of at least one second target object; determining target similarity information between each first target object and a respective second target object according to the predicted target position information, the historical target appearance feature sequence, the current target position information, and the current target appearance feature; determining blocking object similarity information according to the predicted blocking object position information, the historical blocking object appearance feature sequence, the current target position information, and the current target appearance feature; and determining a tracking trajectory of the at least one first target object according to the target similarity information and the blocking object similarity information. By using an implementation solution of the method above, the apparatus for target tracking determines the predicted blocking object position information of the blocking object according to the historical image frame adjacent to the current image frame, determines the historical blocking object appearance feature sequence of the blocking object according to the historical image frame sequence before the current image frame, and fuses the predicted blocking object position information and the historical blocking object appearance feature sequence of the blocking object to determine the tracking trajectory of the at least one first target object in the historical image frame, so that during target tracking, because the predicted blocking object position information and the historical blocking object appearance feature sequence of the blocking object are used, the influence of the blocking object on target tracking is reduced, thereby improving the accuracy of target tracking.

It should be noted that, in this text, the terms “include”, “contain”, or any other variations thereof are intended to cover non-exclusive inclusion, so that a process, method, article, or apparatus including a series of elements includes not only those elements, but also other elements that are not explicitly listed, or elements inherent to such a process, method, article, or apparatus. Without more restrictions, an element defined by the sentence “including a . . . ” does not exclude that there are other identical elements in the process, method, article, or apparatus that includes the element.

By means of the descriptions of the implementation modes above, a person skilled in the art could clearly understand that the method according to the embodiments above may be implemented by means of software plus a necessary universal hardware platform, and of course, also by means of hardware, but the former is a better implementation mode in many cases. On the basis of such an understanding, the technical solutions of the present disclosure or a part thereof contributing to the related art may be essentially embodied in the form of a software product, and the computer software product is stored in a storage medium (such as an ROM/RAM, a magnetic disk, and an optical disk) and includes several instructions so that a device (which may be a mobile phone, a computer, a server, an air conditioner, or a network device, or the like) executes the method according to the embodiments of the present disclosure.

The descriptions above are merely the preferred embodiments of the present disclosure, and are not intended to limit the scope of protection of the present disclosure.

1. A method for target tracking, comprising:
determining, according to a historical image frame adjacent to a current image frame, predicted target position information of at least one first target object and predicted blocking object position information of a respective blocking object, wherein each blocking object is a target closest to a respective first target object;
determining, according to a historical image frame sequence before the current image frame, a historical target appearance feature sequence corresponding to the at least one first target object and a historical blocking object appearance feature sequence corresponding to the blocking object;
determining, according to the current image frame, current target position information and a current target appearance feature of at least one second target object;
determining target similarity information between each first target object and a respective second target object according to the predicted target position information, the historical target appearance feature sequence, the current target position information, and the current target appearance feature;
determining blocking object similarity information according to the predicted blocking object position information, the historical blocking object appearance feature sequence, the current target position information, and the current target appearance feature; and
determining a tracking trajectory of the at least one first target object according to the target similarity information and the blocking object similarity information.

2. The method according to claim 1, wherein determining the target similarity information between each first target object and the respective second target object according to the predicted target position information, the historical target appearance feature sequence, the current target position information, and the current target appearance feature comprises:
determining a target position similarity according to the predicted target position information and the current target position information;
determining a target appearance similarity sequence according to the historical target appearance feature sequence and the current target appearance feature; and
determining the target position similarity and the target appearance similarity sequence as the target similarity information.

3. The method according to claim 1, wherein determining blocking object similarity information according to the predicted blocking object position information, the historical blocking object appearance feature sequence, the current target position information, and the current target appearance feature comprises:
determining a blocking object position similarity according to the predicted blocking object position information and the current target position information;
determining a blocking object appearance similarity according to the historical blocking object appearance feature sequence and the current target appearance feature; and
determining the blocking object position similarity and the blocking object appearance similarity as the blocking object similarity information.

4. The method according to claim 1, wherein determining the predicted target position information of the at least one first target object and the predicted blocking object position information of the respective blocking object comprises:
determining the predicted target position information and the predicted blocking object position information using a neural network capable of implementing single target tracking.

5. The method according to claim 1, wherein determining the historical target appearance feature sequence corresponding to the at least one first target object and the historical blocking object appearance feature sequence corresponding to the blocking object comprises:
determining the historical target appearance feature sequence and the historical blocking object appearance feature sequence using a neural network capable of implementing person re-identification.

6. The method according to claim 1, wherein determining the tracking trajectory of the at least one first target object according to the target similarity information and the blocking object similarity information comprises:
determining a target trajectory association relationship between the first target object and the respective second target object according to the target similarity information and the blocking object similarity information; and
searching the at least one second target object for a target associated with the at least one first target object using the target trajectory association relationship to determine the tracking trajectory of the at least one first target object.

7. The method according to claim 6, wherein determining the target trajectory association relationship between the first target object and the respective second target object according to the target similarity information and the blocking object similarity information comprises:
inputting the target similarity information and the blocking object similarity information to a preset classifier;
determining multiple decision scores of multiple trajectory association relationships using the preset classifier, wherein the multiple trajectory association relationships are trajectory association relationships obtained by performing trajectory association between the at least one first target object and the respective second target object; and
determining, as the target trajectory association relationship, a trajectory association relationship having a highest decision score among the multiple trajectory association relationships.

8. The method according to claim 6, wherein after determining the target trajectory association relationship between the first target object and the respective second target object according to the target similarity information and the blocking object similarity information, the method further comprises:
if a third target object that is not associated with the at least one second target object is determined from among the at least one first target object in the target trajectory association relationship, obtaining the predicted target position information according to a confidence value of the third target object; and
determining the tracking trajectory of the at least one first target object using the target trajectory association relationship and the predicted target position information.

9. The method according to claim 6, wherein after determining the target trajectory association relationship between the first target object and the respective second target object according to the target similarity information and the blocking object similarity information, the method further comprises:
if a fourth target object that is not associated with the at least one first target object is determined from among the at least one second target object in the target trajectory association relationship, adding the fourth target object to a next round of association relationship, wherein the next round of association relationship is an association relationship generated by taking the current image frame as the historical image frame.

10. The method according to claim 4, further comprising:
determining a confidence value corresponding to the first target object using the neural network capable of implementing single target tracking.

11. The method according to claim 8, wherein obtaining the predicted target position information according to the confidence value of the third target object comprises:
if the confidence value of the third target object meets a preset confidence value, obtaining the predicted target position information.

12. The method according to claim 1, wherein a number of the at least one first target object and a number of the at least one second target object are both more than one.

13. An apparatus for target tracking, comprising:
a memory storing processor-executable instructions; and
a processor arranged to execute the stored processor-executable instructions to perform operations of:
determining, according to a historical image frame adjacent to a current image frame, predicted target position information of at least one first target object and predicted blocking object position information of a respective blocking object, wherein each blocking object is a target closest to a respective first target object;
determining, according to a historical image frame sequence before the current image frame, a historical target appearance feature sequence corresponding to the at least one first target object and a historical blocking object appearance feature sequence corresponding to the blocking object;
determining, according to the current image frame, current target position information and a current target appearance feature of at least one second target object;
determining target similarity information between each first target object and a respective second target object according to the predicted target position information, the historical target appearance feature sequence, the current target position information, and the current target appearance feature;
determining blocking object similarity information according to the predicted blocking object position information, the historical blocking object appearance feature sequence, the current target position information, and the current target appearance feature; and
determining a tracking trajectory of the at least one first target object according to the target similarity information and the blocking object similarity information.

14. The apparatus according to claim 13, wherein determining the target similarity information between each first target object and the respective second target object according to the predicted target position information, the historical target appearance feature sequence, the current target position information, and the current target appearance feature comprises:
determining a target position similarity according to the predicted target position information and the current target position information;
determining a target appearance similarity sequence according to the historical target appearance feature sequence and the current target appearance feature; and
determining the target position similarity and the target appearance similarity sequence as the target similarity information.

15. The apparatus according to claim 13, wherein determining blocking object similarity information according to the predicted blocking object position information, the historical blocking object appearance feature sequence, the current target position information, and the current target appearance feature comprises:
determining a blocking object position similarity according to the predicted blocking object position information and the current target position information;
determining a blocking object appearance similarity according to the historical blocking object appearance feature sequence and the current target appearance feature; and
determining the blocking object position similarity and the blocking object appearance similarity as the blocking object similarity information.

16. The apparatus according to claim 13, wherein determining the predicted target position information of the at least one first target object and the predicted blocking object position information of the respective blocking object comprises:
determining the predicted target position information and the predicted blocking object position information using a neural network capable of implementing single target tracking.

17. The apparatus according to claim 13, wherein determining the historical target appearance feature sequence corresponding to the at least one first target object and the historical blocking object appearance feature sequence corresponding to the blocking object comprises:
determining the historical target appearance feature sequence and the historical blocking object appearance feature sequence using a neural network capable of implementing person re-identification.

18. The apparatus according to claim 13, wherein determining the tracking trajectory of the at least one first target object according to the target similarity information and the blocking object similarity information comprises:
determining a target trajectory association relationship between the first target object and the respective second target object according to the target similarity information and the blocking object similarity information; and
searching the at least one second target object for a target associated with the at least one first target object using the target trajectory association relationship to determine the tracking trajectory of the at least one first target object.

19. The apparatus according to claim 18, wherein determining the target trajectory association relationship between the first target object and the respective second target object according to the target similarity information and the blocking object similarity information comprises:
inputting the target similarity information and the blocking object similarity information to a preset classifier; and
determining multiple decision scores of multiple trajectory association relationships using the preset classifier, wherein the multiple trajectory association relationships are trajectory association relationships obtained by performing trajectory association between the first target objects and the respective second target objects; and
determining, as the target trajectory association relationship, a trajectory association relationship having a highest decision score among the multiple trajectory association relationships.

20. A non-transitory computer readable storage medium having stored thereon computer readable instructions that, when executed by a processor, cause the processor to perform a method for target tracking, the method comprising:
determining, according to a historical image frame adjacent to a current image frame, predicted target position information of at least one first target object and predicted blocking object position information of a respective blocking object, wherein each blocking object is a target closest to a respective first target object;
determining, according to a historical image frame sequence before the current image frame, a historical target appearance feature sequence corresponding to the at least one first target object and a historical blocking object appearance feature sequence corresponding to the blocking object;
determining, according to the current image frame, current target position information and a current target appearance feature of at least one second target object;
determining target similarity information between each first target object and a respective second target object according to the predicted target position information, the historical target appearance feature sequence, the current target position information, and the current target appearance feature;
determining blocking object similarity information according to the predicted blocking object position information, the historical blocking object appearance feature sequence, the current target position information, and the current target appearance feature; and
determining a tracking trajectory of the at least one first target object according to the target similarity information and the blocking object similarity information.
